(19) United States
(12) Patent Application Publication
(10) Pub. No.: US 2016/0197740 A1
(43) Pub. Date: Jul. 7, 2016

(54) METHOD FOR THE PROVISION AND TRANSMISSION OF DATA, IN PARTICULAR WITH A LINK TO A VEHICLE

(71) Applicant: WABCO GMBH, Hannover (DE)

(72) Inventors: Rainer Risse, Pattensen-Reden (DE); Udo Ronnenberg, Wedemark (DE); Axel Stender, Hameln (DE)

(73) Assignee: WABCO GmbH, Hannover (DE)

(21) Appl. No.: 14/916,896

(22) PCT Filed: Jul. 10, 2014
(86) PCT No.: PCT/EP2014/001889

§ 371 Date: Mar. 4, 2016

(30) Foreign Application Priority Data
Sep. 13, 2013 (DE) 10 2013 015 370.0

(51) Int. Cl. H04L 12/40

(52) U.S. Cl. CPC H04L 12/40169; H04L 2012/40215; H04L 2012/40273

(57) ABSTRACT

In a method for the provision and transmission of data, in particular with a link to a vehicle, signals are detected as data that are sent as parts of defined message blocks from a transmitter to a receiver. Data SUB-channels (I, II), via which the data are sent, are defined in the message blocks. The message blocks and data SUB-channels (I, II) are assigned to a CAN bus system. The message blocks accommodate two data SUB-channels (I, II), in particular each with a maximum of 2 bytes.

### TECHNICAL FIELD

The invention relates to a method for the provision and transmission of data in a data bus system. In addition, the invention relates to a system for carrying out the method, and a control unit. The main application purpose of the invention is the provision and transmission of defined data of a vehicle to an external receiver. A particularly preferred field of application is the transmission of information from commercial vehicles and trailer vehicles with an electronic braking system, and by means of a telematics function.

### BACKGROUND OF THE INVENTION

Telematics solutions for vehicles are known. For example, the speed and position of a vehicle can be determined in the vehicle and can be transmitted by a telematics unit in the vehicle via a mobile radio link to a receiver with a web server. The operator of the vehicle can retrieve the transmitted data via his computer from the web server, for example via Internet browser software.

Data communication via the so-called CAN bus is widespread in vehicles. Defined messages are standardized or defined by a standard for data transmission via the CAN bus. These data are transmitted with a signal size of max. 64 bits or 8 bytes per message. Along with further components, a CAN message typically contains a CAN identifier (a CAN ID) and a signal, for example as an identifier a code for “speed in km/h” and as a signal “65” (coded in hexadecimal digits).

Vehicles with an electronic braking system, in particular trailer vehicles, are equipped with an electronic control unit (ECU) which can communicate via the vehicle bus with other control units and, where relevant, has connections or interfaces for analogue or digital data lines, also for connection to sensors. The electronic control unit receives a multiplicity of data and can forward these data to a telematics unit for transmission to the web server.

A particular advantage of the standardized vehicle bus system is that the data of all participating devices can be uniquely identified and assigned. A major disadvantage is that the standard must be supplemented accordingly for the transmission of new data and all devices involved in the data transmission process must be adapted, for example by means of a software update.

### SUMMARY OF THE INVENTION

An object of the present invention is to provide the facility to transmit specific information, independently from the development status of the participating components. In particular, user-specific and application-specific vehicle information is intended to be transmitted.

In a method according to an aspect of the invention or more data SUB-channels via which data are transmitted are defined within the message blocks. Each data SUB-channel has a fixed structure, the data content of which can, however, be individually interpreted. The data content is characterized by a unique identifier, an ID. The ID defines how a receiver is to understand the data content.

The message blocks may, for example, be defined message blocks of a CAN bus system. A multiplicity of different data with corresponding identifiers (CAN IDs) is already defined for the CAN bus. A new CAN ID is defined to carry out the method, i.e. for a message block with a defined structure, wherein the latter contains one or more data SUB-channels. The data SUB-channels are assignable by means of their own identifiers (SUB-IDs) to any given data. The signals transmitted via the data SUB-channels are unique due to the assigned SUB-IDs.

The devices connected to the bus system recognize the defined CAN ID and interpret the associated message block as one which contains data SUB-channels. If the devices in any case only have to forward the message block and do not have to interpret it, it suffices if these devices simply recognize the message block as a CAN message and forward it. Only the interpreting devices need to have knowledge of the structure of the data SUB-channels and SUB-IDs. Any given device-specific, vendor-specific or other proprietary data can thus be transmitted via the CAN bus with a single newly defined CAN ID.

Alternatively to the definition of the new CAN ID, an already defined CAN ID can also be used. Only a part of the already defined CAN ID is actually required in a specific application. A CAN message provided with an unneeded CAN ID can therefore be modified in order to define data SUB-channels. Only the transmitter and receiver, and not further devices connected to the bus system, need to have knowledge of the new meaning of the previously unneeded CAN ID and the definition of the data SUB-channels. In this way, proprietary messages can be exchanged between the transmitter and receiver without further devices connected to the transmitter or to the receiver having to be adapted.

The message blocks and data SUB-channels can be assigned to a CAN bus system in a vehicle. The CAN ID for the data block provided with data SUB-channels is either specifically defined or selected in such a way that it is not required in the vehicle or in the application.

A message block advantageously accommodates two data SUB-channels, in particular each with a maximum of two bytes. A CAN message typically contains an 8-byte data field. This then accommodates two 2-byte data SUB-channels, wherein further bytes must be provided for each SUB-identifier.

A data SUB-channel is advantageously assigned to a SUB-identifier comprising, in particular, 2 bytes, and contains a signal comprising a maximum of 2 bytes. The data field of a typical CAN message then contains 2×2 bytes for SUB-identifiers and 2×2 bytes of signals.

A system according to an aspect of the invention is provided to carry out the method according to an aspect of the invention. A bus system, in particular a CAN bus system, is present in a vehicle for the transmission of data. An electronic control unit (ECU) is provided in the vehicle in order to provide the data and an interface to transmit the data to external receivers. The bus system enables a data transmission of at least one message block with one or more data SUB-channels.

The electronic control unit is preferably a brake control unit of an electronic braking system, of the type known from vehicles with electro-pneumatic brakes. However, it may also be a different control unit, for example without a special link to the braking system.

According to an aspect of the invention, the interface may be a telematics unit. With this unit, data are transmitted wirelessly to an external receiver. A simpler interface is also possible, e.g. in the form of a diagnostic connector, and for connection to an external diagnostic device.

The telematics unit advantageously communicates with a web server, in particular via a mobile radio link. The web server is operated, for example, by the provider of a telematics portal and is made available to the operator of the vehicle for a fee. The mobile radio link is determined by the existing facilities and the required bandwidth. For example, a link can be set up via GSM, UMTS, LTE or satellite radio (such as Iridium). The vehicle operator can access the web server with his own computer as a client via the Internet, e.g. via his own Internet browser.

According to a further concept of the invention, the provision and transmission of defined data can be requested via the interface. In this case, the transmitter and receiver operate in both directions and are therefore the transmitter/receiver or the receiver/transmitter. The external receiver transmits to the interface (transmitter) a message with which the transmission of defined data is requested. The request and transmission can be carried out in the same format, i.e. via the aforementioned data SUB-channels.

According to a further concept of the invention, data are generated from basic data in the electronic control unit. The generated data are then transmitted to the external receiver. New data can thus be generated and transmitted from links or functions. As a result, bandwidth is saved compared with the transmission of all basic data.

Functions or links are advantageously transmitted via the interface to the electronic control unit in order to acquire data. The control unit then transmits correspondingly generated data to the interface. In this way, hitherto unknown functions and links can be introduced into the control unit, i.e. via the data SUB-channels. In this case also, the transmitter and receiver operate in both directions, i.e. as transmitter/receiver on the one hand and as receiver/transmitter on the other hand.

According to a further concept of the invention, it is provided that at least one sensor is connected to the electronic control unit, the data of which are not used for a main function of the electronic control unit, and that these data are transmitted from the electronic control unit via at least one of the data SUB-channels (I, II) to the interface. If the main function of the electronic control unit is the control of an electronic braking system in a vehicle, this accordingly involves a typical EBS-ECU, wherein, according to the current prior art, wheel speed and a lateral acceleration are primarily measured and processed by directly connected sensors. A temperature has not hitherto been measured by a sensor connected to the ECU of the electronic braking system. With the system according to an aspect of the invention, for example, the acquisition, provision and transmission of the data of a temperature sensor connected to the ECU are possible, i.e. via one of the aforementioned data SUB-channels.

The subject-matter of the invention is also a control unit for carrying out the method according to an aspect of the invention and/or for use in a system according to an aspect of the invention. This preferably involves a brake control unit with adapted functionality.

Further features of the invention can be found in the description below of the accompanying drawings. The drawings are provided purely for illustrative purposes and are not intended to limit the scope of the present invention.

### BRIEF DESCRIPTION OF THE DRAWINGS

Advantageous embodiments of the invention are explained in detail below with reference to drawings, in which:

FIG. 1 shows a diagram illustrating the information flow from a signal sensor through to the user,

FIG. 2 shows a diagram illustrating different data SUB-channels within two CAN messages with the same CAN ID.

### SUMMARY OF THE INVENTION

In a commercial vehicle (not shown) with an electronic braking system EBS and a telematics unit, associated electronic control units (ECUs) are interconnected via a CAN bus and exchange information electronically via said bus. The electronic control unit of the braking system, i.e. the EBS-ECU, receives signals from sensors via analog or digital inputs. The EBS-ECU can furthermore receive signals provided by other ECUs via the CAN bus.

The transmission via the CAN bus is standardized for a series of signals. Each CAN message block is structured according to a defined pattern, inter alia with an identifier, i.e. a CAN ID, on the one hand and, for example, four associated signals on the other hand, the latter represented by a total of 64 bits or 8 bytes. A fixed assignment is defined for each signal using the CAN ID and the position within the 8-byte sequence. Due to the predefined standardization, each unit connected to the CAN bus can read and understand the CAN message.

By no means all information occurring in a commercial vehicle is taken into account in the standardized CAN messages. New information is also continually added, depending on the application and technical development.

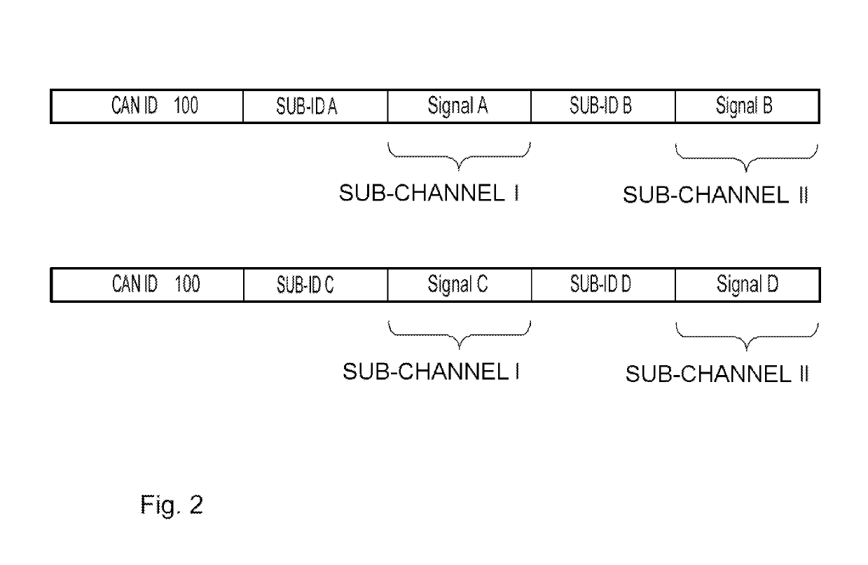

In order to be able to exchange hitherto unstandardized data via the CAN bus also, data SUB-channels are defined according to an aspect of the invention for signals within a CAN message block. A possible data structure is shown in FIG. 2. A CAN message block with the selected or newly defined CAN ID 100 shown by way of example contains 8 bytes of information as usual. Here, the first 2 bytes designate a SUB-identifier, i.e. a SUB-ID A. This is followed by 2 bytes to represent a signal A and then a SUB-ID B and a signal B. The signals A and B are contents of data SUB-channels I, II within the CAN message with the CAN ID 100.

The EBS-ECU present in the commercial vehicle knows the described data structure and interprets a message with the CAN ID 100 accordingly. The same applies to receivers which are intended to interpret the message. In the present case, two SUB-IDs and the associated signals are provided for each CAN message.

Through the definition of the SUB-IDs, the data SUB-channels I, II are individually usable and can transmit virtually any signals, e.g. according to the following table (for the signals A-Z):

| | | | Data SUB- | |
|---|---|---|---|---|
| Information | CAN ID | SUB-ID | channel | Signal |
| Load | 100 | A | I | A |
| Status of driver's door | 100 | B | II | B |
| External temperature | 100 | C | I | C |
| Internal temperature | 100 | D | II | D |
| . . . | 100 | . . . | . . . | . . . |
| Gearbox oil level | 100 | Z | II | Z |

Different sensors are connected to the EBS-ECU and these sensors supply signals to digital or analog inputs of the EBS-ECU. The signal sensor A supplies a signal A to the EBS-ECU, the signal sensor B supplies a signal B, etc.

The signals are given their own identifier in the EBS-ECU. The signal A is given the SUB-ID A, etc. The SUB-ID A, signal A, SUB-ID B and signal B are assigned to the CAN message with the CAN ID 100 and are transmitted as a CAN message to the telematics ECU.

The resulting CAN messages are transmitted from the telematics ECU via a mobile radio link (UMTS) to a receiver, for example a Web server of a telematics portal for visualizing telematics data, and can be retrieved or viewed by the user via the Internet, e.g. via browser software on the user's computer.

A new CAN message can then be generated, again with the CAN ID 100, but with the SUB-IDs C and D. This CAN message also reaches the user on the transmission path described.

The user can differentiate the signals C and D from the signals A and B on the basis of the SUB-IDs, despite the identical CAN ID 100. Only the software on the user client on the one hand and the software on the EBS-ECU on the other hand need to know the meaning of the SUB-IDs in order to be able to understand the underlying information. The telematics ECU and the Web server merely forward the CAN message with the CAN ID 100.

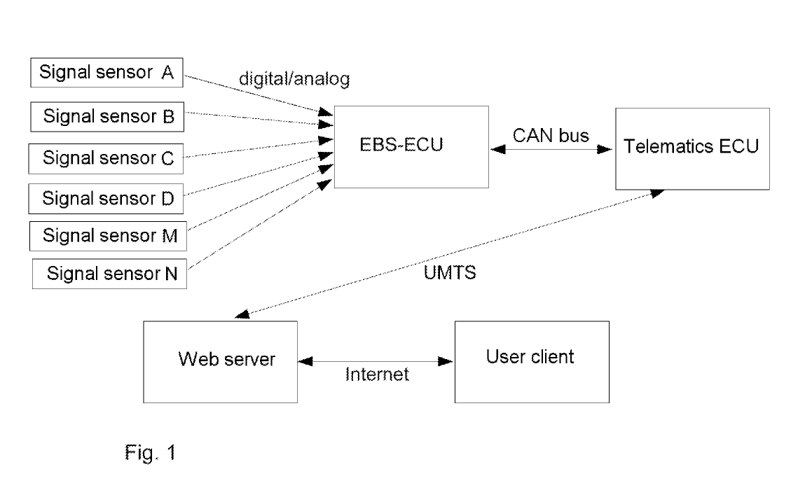

In FIG. 1, the arrows of the CAN bus, UMTS and Internet information paths are drawn as double arrows. The function of retrieving a defined signal is associated therewith. The user can thus retrieve the signal of the sensor A in a targeted manner. The EBS-ECU then generates and transmits a CAN message with the SUB-ID A and the current signal A.

Signals from sensors can also be interlinked in the EBS-ECU on the basis of stored functions. The result of the linking is given a SUB-ID and is transmitted as a component of the CAN message with the CAN ID 100.

In a further embodiment, the functions stored in the EBS-ECU can be modified by parameters transmitted by the user, resulting in new, modified functions with correspondingly new signals which can in turn be transmitted with their own SUB-ID as part of a CAN message.

In the preceding description, the invention is explained exclusively in connection with CAN messages. However, the invention is also usable in conjunction with other message formats, in particular with bus systems or predefined data packets. The generation and use of SUB-channels within existing data structures is important. The main field of application of the invention is the communication via a CAN bus system with a vehicle, in particular in conjunction with a telematics function. By means of the invention, a large number of different signals obtained in the vehicle can be transmitted with a high degree of flexibility via the CAN bus to a receiver.

While the above description constitutes the preferred embodiments of the present invention, it will be appreciated that the invention is susceptible to modification, variation and change without departing from the proper scope and fair meaning of the accompanying claims.

1. A method of providing and transmitting data in a data bus system, the method comprising the steps of:
acquiring signals as data;
sending the data as parts of defined message blocks from a transmitter to a receiver, wherein the message blocks contain a definition of one or more data SUB-channels (I, II) via which the data are transmitted.

2. The method as claimed in claim 1, wherein the message blocks and data SUB-channels (I, II) are assigned to a CAN bus system.

3. The method as claimed in claim 1, wherein at least one of the message blocks accommodates two data SUB-channels (I, II).

4. The method as claimed in claim 1, wherein at least one of the at least one data SUB-channel is assigned to a SUB-identifier and contains a signal comprising a maximum of 2 bytes.

5. A system providing and transmitting data in a data bus system in a vehicle, the system comprising
a data bus system, configured for transmitting the data with one or more data SUB-channels (I, II) within a data block
an electronic control unit (EBS-ECU) for configured for providing the data, and
an interface configured for transmitting the data to receivers remote from the vehicle.

6. The system as claimed in claim 5, wherein the interface is a telematics unit (telematics ECU).

7. The system as claimed in claim 6, wherein the telematics unit communicates with a web server, in particular via a mobile radio link (UMTS).

8. The system as claimed in claim 5, wherein the provision and transmission of defined data is performed in response to a request received via the interface.

9. The system as claimed in claim 5, characterized in that wherein the electronic control (EBS-ECU) unit is configured for generating the data from basic data and for transmitting the generated data.

10. The system as claimed in claim 9, wherein functions or links for generating data are transmitted via the interface to the electronic control unit (EBS-ECU), and wherein the electronic control unit then generates correspondingly generated data.

11. The system as claimed in claim 5, wherein at least one sensor is connected to the electronic control unit, the data of which are not used for a main function of the electronic control unit, and in that these data are transmitted from the electronic control unit via at least one of the data SUB-channels (I, II) to the interface.

12. A control unit configured for receiving functions or links via the internet for generating data, for correspondingly generating the data as message blocks, and for transmitting the message blocks from the electronic control unit to an interface, each of the message blocks including at least one data SUB-channel assigned to a SUB-identifier.

13. The control unit as claimed in claim 12, wherein each of the message blocks has two data SUB-channels, each SUB-channel having a maximum of 2 bytes.

14. The method as claimed in claim 12, wherein the SUB-identifier comprises 2 bytes.

15. The method as claimed in claim 3, wherein each of the two data SUB-channels has a maximum of 2 bytes.

16. The method as claimed in claim 4, wherein the SUB-identifier comprises 2 bytes.
